(19) United States
(12) Patent Application Publication
(10) Pub. No.: US 2014/0097626 A1
(43) Pub. Date: Apr. 10, 2014

(54) CONNECTION STRUCTURE OF DOOR LATCH AND DOOR HANDLE BASE

(71) Applicants: HYUNDAI MOTOR COMPANY, Seoul (KR); KIA MOTORS CORPORATION, Seoul (KR)

(72) Inventors: Jae Min Ryu, Seoul (KR); Hyong Don Kim, Incheon (KR)

(73) Assignees: Kia Motors Corporation, Seoul (KR); Hyundai Motor Company, Seoul (KR)

(21) Appl. No.: 13/771,618

(22) Filed: Feb. 20, 2013

(30) Foreign Application Priority Data
Oct. 10, 2012 (KR) 10-2012-0112306

(51) Int. Cl. E05B 3/00

(52) U.S. Cl. CPC E05B 3/00
USPC 292/348

(57) ABSTRACT

A connection structure of a door latch and a door handle base, may include a door latch adapter mounted at the door latch, and the door handle base mounted at a door handle, wherein a coupled part formed at the door latch adapter may be insertedly coupled to a coupling groove formed at the door handle base.

### CROSS-REFERENCE TO RELATED APPLICATION

The present application claims priority to Korean Patent Application No. 10-2012-0112306, filed on Oct. 10, 2012 in the Korean Intellectual Property Office, the entire contents of which is incorporated herein for all purposes by this reference.

### BACKGROUND OF THE INVENTION

1. Field of the Invention

The present invention relates to a connection structure of a door latch and a door handle base, and more particularly, to a connection structure of a door latch and a door handle base capable of obtaining coupling property and simplification of the structure by directly connecting a door latch adapter mounted at the door latch to the door handle base.

2. Description of Related Art

In general, a door module, which is mounted at a door, includes a door latch, a door latch adapter, and a door handle base.

Meanwhile, a connection structure of a door latch and a door handle base according to the prior art includes a door latch adapter 30 and a base support bracket 40 provided between a door latch 10 and a door handle base 20 so as to connect them with each other, as shown in FIG. 1.

That is, in the connection structure of the door latch and the door handle base, the door latch adapter 30 is connected to the door latch 10, the base support bracket 40 is connected to the door handle base 20, and the door latch adapter 30 is connected to the base support bracket 40.

However, in the connection structure of the door latch and the door handle base according to the prior art, the base support bracket 40 interferes with a door frame and a door outer rail at the time of being assembled at the door, to thereby degrade assembly property.

Further, in the connection structure of the door latch and the door handle base according to the prior art, the base support bracket 40 strikes the door handle base 20 at the time of colliding with a side surface, such that the door handle base 20 allows a door handle to move, while rotating, to thereby open a door.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a connection structure of a door latch and a door handle base capable of obtaining coupling property and simplification of the structure by removing a base support bracket and directly connecting a door latch adapter mounted at the door latch to the door handle base.

A connection structure of a door latch and a door handle base may include a door latch adapter mounted at the door latch, and the door handle base mounted at a door handle, wherein a coupled part formed at the door latch adapter is insertedly coupled to a coupling groove formed at the door handle base.

A pair of coupled parts is provided so as to correspond each other and may include catching jaws formed at outer sides thereof so as to be caught and supported by the coupling grooves.

The pair of coupled parts may include an inner side and an outer side inclined with respect to a longitudinal axis of the coupled parts.

A pair of coupling grooves is formed and may have the pair of coupled parts each inserted thereinto.

A reinforcement member is formed between the coupling grooves.

The pair of coupled parts may have elastic force in a direction pushing away each other.

The coupling groove is formed at a front of a support member formed at the door handle base and the support member is provided with a moving space formed therein so that the coupled part insertedly coupled to the coupling groove moves in a length direction of the coupled part.

The moving space communicates with the coupling groove.

The door latch adapter and the door handle base are connected to each other by a connection member.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### BRIEF DESCRIPTION OF THE DRAWINGS

FIG. 1 is a perspective view showing a connection structure of a door latch and a door handle base according to the prior art.

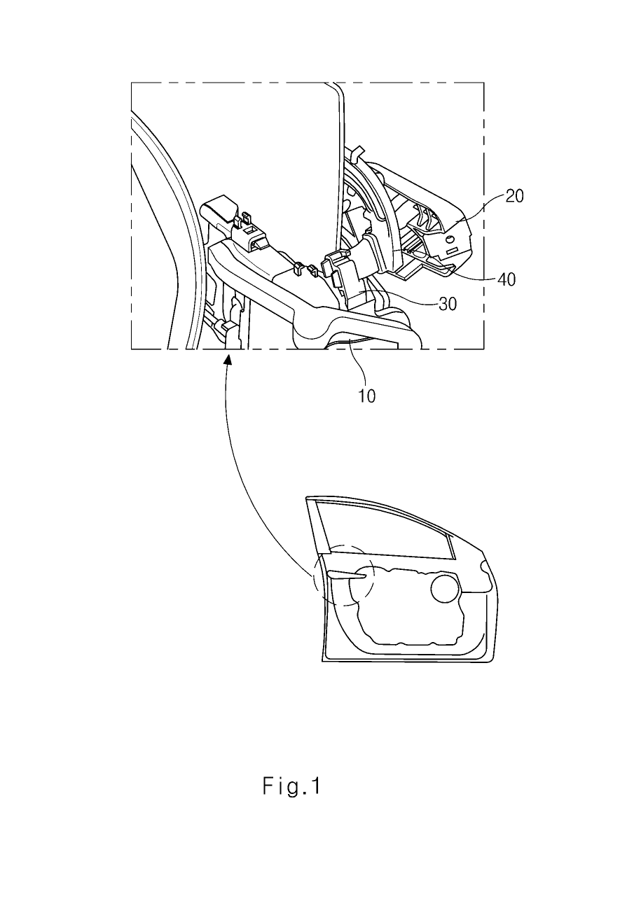

FIG. 2 is a perspective view showing a connection structure of a door latch and a door handle base according to an exemplary embodiment of the present invention.

FIG. 3 is a partially enlarged perspective view showing the connection structure of the door latch and the door handle base according to an exemplary embodiment of the present invention.

FIG. 4 is a partially enlarged front view showing the connection structure of the door latch and the door handle base according to an exemplary embodiment of the present invention.

FIG. 5 is a perspective view showing a connection member of the connection structure of the door latch and the door handle base according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In a connection structure of a door latch and a door handle base according to the present invention, a door latch adapter mounted at the door latch is connected to the door handle base mounted at a door handle through a coupled part and a coupling groove, thereby increasing assembly property of the door latch and the door handle base and simplification of the structure.

Hereinafter, embodiments of the present invention will be described in detail with reference to the accompanying drawings so that they can be easily practiced by those skilled in the art to which the present invention pertains. However, the present invention may be modified in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

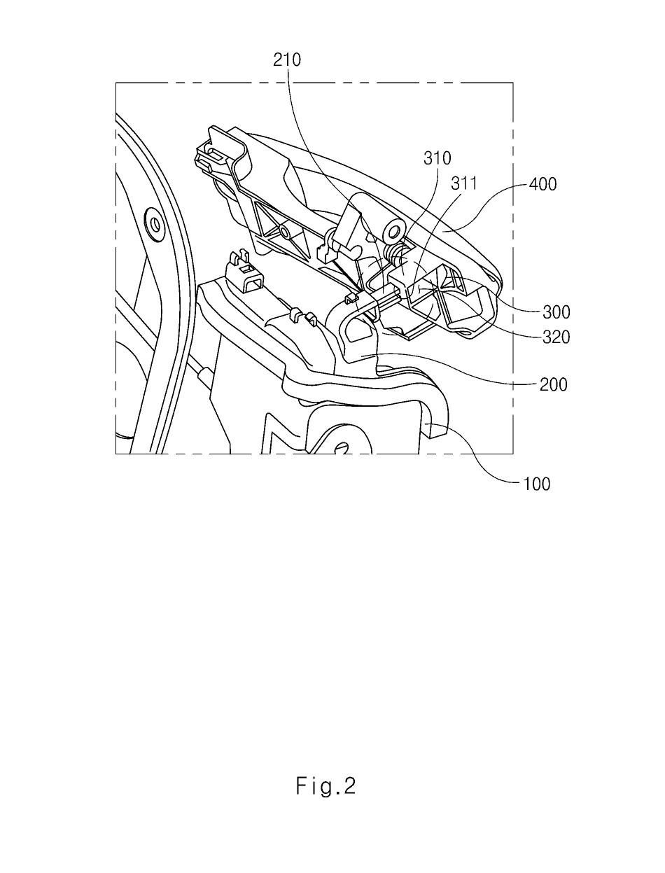

A connection structure of a door latch and a door handle base according to an exemplary embodiment of the present invention includes a door latch adapter 200 mounted at a door latch 100, and a door handle base 300 mounted at a door handle 400, as shown in FIG. 2.

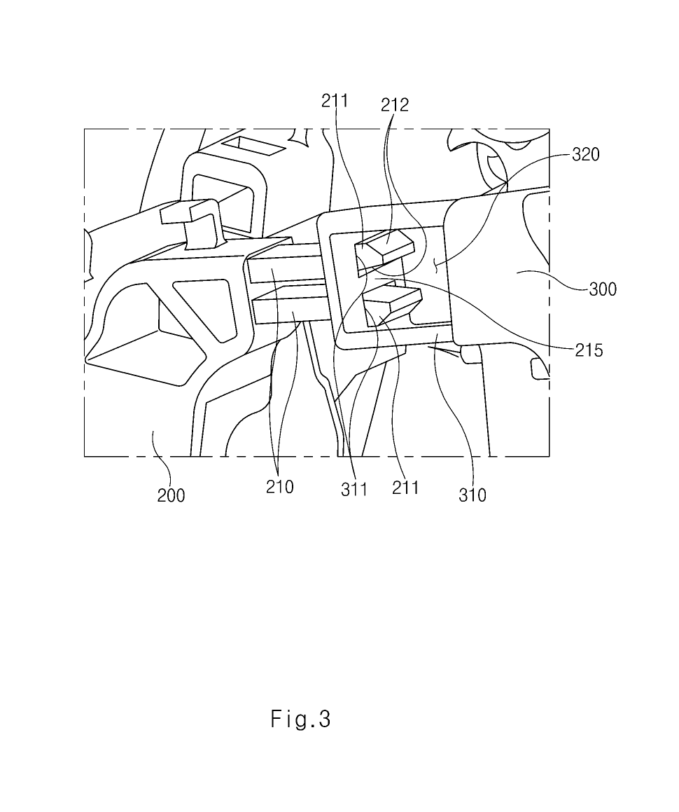

In this configuration, a coupled part and a coupling groove are each formed between the door latch adapter 200 and the door handle base 300, as shown in FIG. 3, wherein the latch adapter 200 and the door handle base 300 are connected with each other by inter-coupling of the coupled part and the coupling groove, thereby making it possible to obtain assembly property of the door latch adapter 200 and the door handle base 300 and simplification of the structure.

For example, a coupled part 210 is formed at the door latch adapter 200 and a coupling groove 311 is formed in the door handle base 300 so as to insertedly couple the coupling part 210 thereinto.

A pair of coupled parts 210 is provided at the door latch adapter 200 so as to correspond to each other and have catching jaws 211 formed at outer sides thereof so as to be caught and supported by the coupling grooves 311.

That is, when the pair of coupled parts 210 are inserted into the coupling grooves 311 and then pulled, the catching jaws 211 of the coupled parts 210 are caught and supported by outer peripheral surfaces of the coupling grooves 311 to prevent a separation of the coupled parts 210, to thereby connect the door latch adapter 200 to the door handle base 300.

A reinforcement member 215 may be formed between the coupling grooves 311 so as to reinforce the coupling grooves 311.

Meanwhile, the pair of coupled parts 210 have an inner side and an outer side formed as inclined surfaces 212, wherein the inclined surfaces 212 guide the coupled parts 210 in the case in which the pair of coupled parts 210 are inserted into the coupling grooves 311, thereby increasing coupling property of the coupled parts 210.

Moreover, the pair of coupled parts 210 may increase areas which are mutually compressed through the inclined surfaces 212 corresponding to each other at the inner sides thereof, such that the catching jaws 211 of the coupled part 210 may be maximally matched, thereby making it possible to increase the coupling property.

Meanwhile, the pair of coupled parts 210 has elastic force in a direction pushing each other, thereby maintaining more stable fixing force through the elastic force in the case in which the pair of coupled parts 210 is insertedly coupled to the coupling grooves 311.

Meanwhile, a pair of coupling grooves 311 is formed and the pair of coupling grooves 311 include the pair of coupled parts 210 each insertedly coupled thereinto, thereby increasing the assembly property between the coupled parts 210 and the coupling grooves 311.

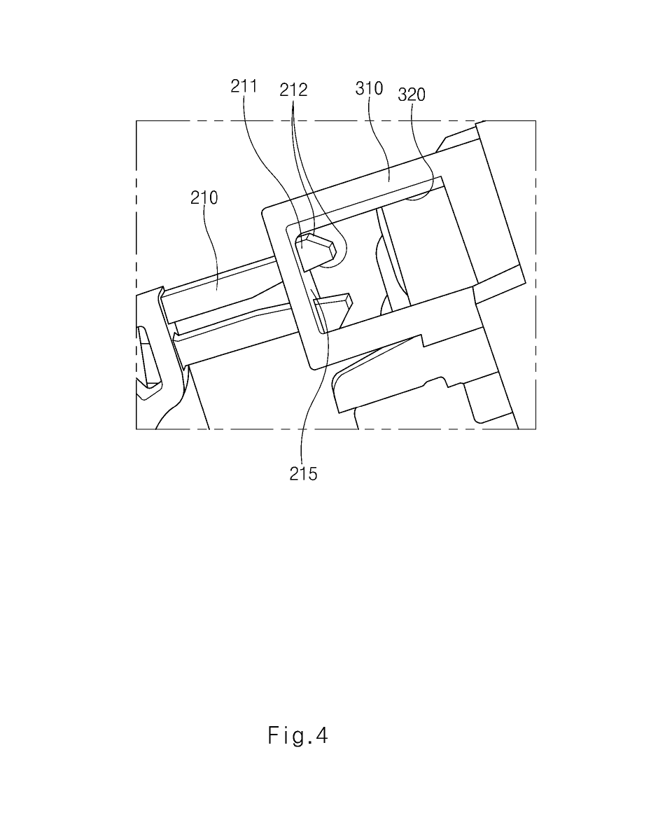

Meanwhile, as shown in FIG. 4, the coupling groove 311 is formed at the front of a support member 310 formed at the door handle base 300 and the support member 310 is provided with a moving space 320 provided therein so that the coupled parts 210 coupled to the coupling grooves 311 move in a length direction. Therefore, even though a movement phenomenon of the door latch adapter 200 or the door handle base 300 occurs while the coupled parts 210 move in the length direction in the moving space 320, the stable connection may be maintained.

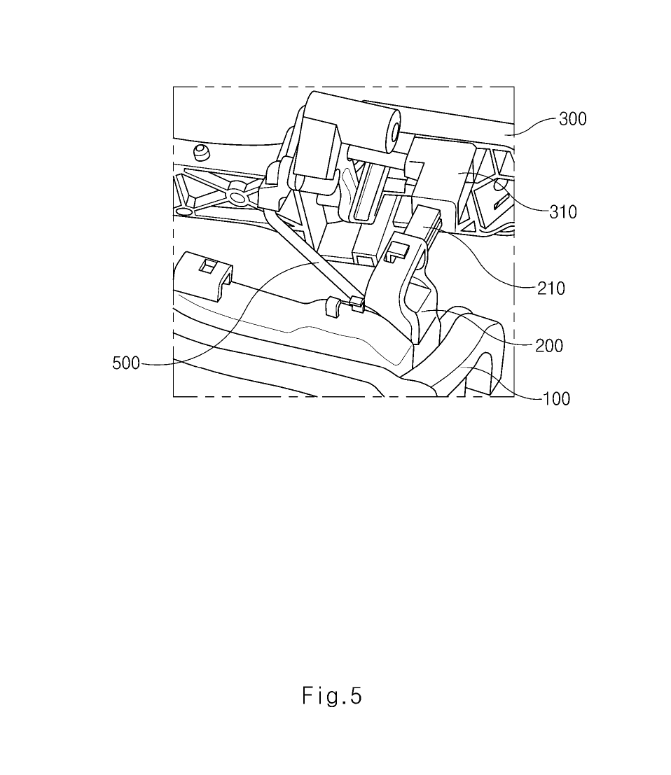

Meanwhile, as shown in FIG. 5, the door latch adapter 200 and the door handle base 300 are connected to each other by a connection member 500, wherein the connection member 500 has both side ends each hinge-coupled to the door latch adapter 200 and the door handle base 300. Therefore, the connection member 500 forms another connection point together with a connection point between the coupled part 210 and the coupling groove 311, such that the door latch adapter 200 and the door handle base 300 may be stably supported and the rotation thereof may be prevented by the two connection points.

Therefore, in the connection structure of the door latch and the door handle base, the door latch is directly connected to the door handle base through the coupled parts and the coupling grooves without any separate brackets, thereby making it possible to obtain the assembly property and the simplification of the structure.

According to an exemplary embodiment of the present invention, the door latch adapter mounted at the door latch is connected directly to the door handle base, thereby making it possible to obtain coupling property and simplification of the structure.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A connection structure of a door latch and a door handle base, comprising:
a door latch adapter mounted at the door latch; and
the door handle base mounted at a door handle,
wherein a coupled part formed at the door latch adapter is insertedly coupled to a coupling groove formed at the door handle base.

2. The connection structure of the door latch and the door handle base of claim 1, wherein a pair of coupled parts are provided so as to correspond each other and include catching jaws formed at outer sides thereof so as to be caught and supported by the coupling grooves.

3. The connection structure of the door latch and the door handle base of claim 2, wherein the pair of coupled parts include an inner side and an outer side inclined with respect to a longitudinal axis of the coupled parts.

4. The connection structure of the door latch and the door handle base of claim 2, wherein a pair of coupling grooves are formed and have the pair of coupled parts each inserted thereinto.

5. The connection structure of the door latch and the door handle base of claim 4, wherein a reinforcement member is formed between the coupling grooves.

6. The connection structure of the door latch and the door handle base of claim 2, wherein the pair of coupled parts have elastic force in a direction pushing away each other.

7. The connection structure of the door latch and the door handle base of claim 1, wherein the coupling groove is formed at a front of a support member formed at the door handle base and the support member is provided with a moving space formed therein so that the coupled part insertedly coupled to the coupling groove moves in a length direction of the coupled part.

8. The connection structure of the door latch and the door handle base of claim 7, wherein the moving space communicates with the coupling groove.

9. The connection structure of the door latch and the door handle base of claim 1, wherein the door latch adapter and the door handle base are connected to each other by a connection member.
